(19) United States
(12) Patent Application Publication
(10) Pub. No.: US 2012/0209501 A1
(43) Pub. Date: Aug. 16, 2012

(54) method and device for determining a starter speed of a starter of a starter system

(76) Inventors: Stefan Tumback, Stuttgart (DE); Falco Sengebush, Stuttgart-Feuerbach (DE)

(21) Appl. No.: 13/390,566

(22) PCT Filed: Jul. 7, 2010
(86) PCT No.: PCT/EP2010/059691

§ 371 Date: Apr. 26, 2012

(30) Foreign Application Priority Data
Sep. 4, 2009 (DE) 10 2009 029 207.1

(51) Int. Cl. F02N 11/08

(52) U.S. Cl. 701/113; 123/179.4

(57) ABSTRACT

A method and device for determining a starter speed of a starter of a start-stop system. At least one electrical variable of the starter is ascertained during a run-up of the starter, and the current starter speed of the starter is determined as a function of it.

### FIELD OF THE INVENTION

The present invention relates to the area of starter systems in motor vehicles.

### BACKGROUND INFORMATION

Starter systems, which normally have an electric motor for starting a combustion engine, are used in vehicle drive units to start the combustion engine from a stopped state. In this context, the combustion engine is normally started with the aid of a starter having an electric motor and a starter pinion, which is meshed with a ring gear of the combustion engine. In addition to classical starters having a starter pinion, belt starters, integrated starters, and hybrid drives having a switchable clutch between the electric motor and the combustion engine are also used.

In the case of one starter which has a starter pinion, the pinion is first synchronized with the speed of the combustion engine that is running down. When synchronous operation is reached, the pinion is meshed with the rotating ring gear, in order to achieve a rapid restart of the combustion engine that is running down. In this context, a synchronization that is exact as possible is important, in order to minimize noise generation and wear.

### SUMMARY

In accordance with the present invention, a particular ratio of the speed of the starter to the starting duration exists when standard conditions are present, and a deviation from the standard conditions may be corrected using an electrical variable measured during the run-up of the starter. In this context, the current starter speed of the starter may be deduced, in particular, from the measured electrical variable. The particular ratio mentioned above may be ascertained, using various measurements of the run-up speed in relation to the starting duration of the starter under standard conditions. The ascertained, standard conditions or reference data are preferably stored in a look-up table. During the run-up of the starter, its speed is increased.

However, since it is to be expected that in special application cases, the boundary conditions influencing the starter speed may deviate markedly from the standard conditions, an example embodiment of the present invention provides that the standard conditions be corrected in light of the current starter speed. In this context, parameters that may cause these deviations include the internal resistance and the voltage of the battery, the resistances from the wiring to the starter, and the resistances in the starter itself. This may cause a significant deviation of the actual starter speed from the speed stored in the look-up table. However, according to the example embodiment of the present invention, the standard conditions, in particular, the stored starting duration, may be adjusted as a function of the specific starter speed actually determined. Consequently, according to the example embodiment of the present invention, noise generation, wear and even damage to the pinion and ring gear may be minimized or prevented.

Accordingly, an example method for determining a starter speed of a starter of a starter system, e.g., a start-stop system, is provided, which includes the steps of measuring at least one electrical variable of the starter during a run-up of the starter, and determining the current starter speed as a function of the at least one measured electrical variable.

Further provided is a computer program product, which causes the example method of the present invention for determining a starter speed of a starter of a starter system to be executed on a program-controlled device.

A computer program product such as a computer program means may be made available or supplied, for example, as a storage medium such as a memory card, a USB stick, a floppy disk, a CD-ROM, a DVD, or even in the form of a data file of a server in a network that is able to be down-loaded. This may take place, for example, in a wireless communication network via the transmission of a corresponding file having the computer program product or the computer program means.

In addition, an example device for determining a starter speed of a starter of a starter system, for example, a start-stop system, is provided. The example device includes a measuring arrangement to measure at least one electrical variable of the starter during a run-up of the starter, and a determining arrangement to determine the current starter speed as a function of at least one measured electrical variable.

The specific arrangement, in particular, first measuring arrangement and the determining arrangement, may be implemented in hardware or also in software. In the case of a hardware implementation, the specific arrangement may take the form of an apparatus, e.g., a computer or microprocessor, device, or also a part of a system, e.g., a computer system. In the case of a software implementation, the specific arrangement may take the form of a computer program product, a function, a routine, a part of a program code, or an executable object.

Furthermore, a starter system is provided, which has a device of the present invention for determining a starter speed of a starter of a starter system, e.g., a start-stop system, of a vehicle drive unit, as explained above. Along the lines of the present application, a vehicle may be a passenger car, a cargo truck, a commercial vehicle or a motorcycle.

According to a preferred further refinement, a starter current is measured during the run-up of the starter in order to measure the at least one electrical variable. The measuring of the starter current is the simplest embodiment of measuring an electrical variable, with the aid of which the current starter speed may be deduced.

According to a further preferred refinement, an integration value is provided by integrating the measured starter current over the time of the run-up of the starter. The integration value provides the option of ascertaining the amount of current taken up during the run-up. The ascertained amount of current provides reliable information for inferring the speed of the starter.

According to a further preferred refinement, the measured starter current is corrected using a specific offset, and subsequently, an integration value is provided by integrating the corrected starter current over the time of the run-up of the starter. During the run-up of the starter, electrical and mechanical losses occur that are not directly proportional to the energy taken up by the starter. Therefore, these may invalidate the speed prediction. The prediction may be improved by taking these losses into consideration. In this context, the preferred starting point is the subtraction of a constant offset during the integration of the current or the power.

According to a further preferred refinement, to determine the current starter speed, it is measured as a function of the provided integration value, a reference speed and a reference integration value. The current is measured while the starter starts. This may take place, in particular, directly in the control unit of the starter. The current is then integrated during the run-up of the starter. Points of reference for time, speed and integrated current for a reference situation, for example, average battery and average wiring, are stored in a look-up table. These references may be stored in the look-up table as, in particular, a reference speed and reference integration value for, namely, the respective point of reference. Then, the current speed or starter speed may be calculated by scaling or bending the reference speed in proportion to the integrated current at this instant.

According to a further preferred refinement, the current starter speed is calculated from a quotient of a product of the integration value and the reference speed, and the reference integration value.

According to a further preferred refinement, the current starter speed or speed is calculated with the aid of the following equation (1):

$${n}_{act} ( {t}_{1} ) = \frac{{n}_{ref} ( {t}_{1} ) \cdot {I}_{int} ( {t}_{1} )}{{I}_{ref} ( {t}_{1} )} , \qquad ( 1 )$$

where n_{act}(t₁) denotes the calculated speed at time t₁, n_{ref}(t₁) denotes the reference speed at time t₁, Iᵢₙₜ(t₁) denotes the current integral at time t₁ and I_{ref}(t₁) denotes the current integral from the reference measurement at time t₁.

The reference speed and the reference integration value for a plurality of instances during the time of the starter run-up are preferably stored in a look-up table (LUT).

The example of the look-up table is the simplest option for storing the reference speed and the reference integration value in a coordinated manner. This results in a rapid comparison during use.

According to a further preferred refinement, the step of measuring at least one electrical variable of the starter during a run-up of the starter includes measuring a starter current during the starter run-up, measuring a starter voltage dropping at the starter during the starter run-up, and calculating the electrical energy taken up by the starter as a function of the measured starter current and the measured starter voltage. An advantage of this is that as a rule, the measurement of voltage is markedly more accurate than a measurement of current. Consequently, a calculation error that could occur due to the tolerance-encumbered measurement of current may be advantageously compensated for.

According to a further preferred refinement, the step of determining the current starter speed as a function of the at least one measured electrical variable includes calculating the current starter speed as a function of a reference speed, the calculated electrical energy and a reference energy. Consequently, in the present case, the desired speed or current starter speed is obtained by multiplying the reference speed by the square root of the energy ratio.

According to a further preferred refinement, the current starter speed is calculated as a product of the reference speed and a square root of a quotient of the calculated electrical energy and the reference energy. In this context, the current starter speed may be preferably calculated using the following equation (2):

$${n}_{act} ( {t}_{1} ) = {n}_{ref} ( t 1 ) \cdot \sqrt{\frac{E ( {t}_{1} )}{{E}_{ref} ( {t}_{1} )}} \qquad ( 2 )$$

where n_{act}(t₁) denotes the calculated speed at time t₁, n_{ref}(t₁) denotes the reference speed at time t₁, E(t₁) denotes the taken-up energy at time t₁, and E_{ref}(t₁) denotes the taken-up energy from the reference measurement at time t₁.

Additionally provided is an example method for setting a starting duration of a pinion-type starter of a start-stop system, which includes the steps of determining the current starter speed of the pinion-type starter according to the above-mentioned method, and of setting the starting duration of the pinion-type starter as a function of the determined, current starter speed in such a manner, that the starter speed becomes synchronous with the speed of an engine that is running down.

Furthermore, an example device for setting a starting duration of a pinion-type starter of a start-stop system is provided. The device includes a determining arrangement to determine the current starter speed of the pinion-type starter according to the above-mentioned method, and a setting arrangement to set the starting duration of the pinion-type starter as a function of the determined, current starter speed in such a manner, that the starter speed becomes synchronous with the speed of an engine that is running down.

### BRIEF DESCRIPTION OF THE DRAWINGS

Further exemplary embodiments of the present invention are illustrated in the figures and explained in greater detail below.

FIG. 1 shows a schematic flow chart of an example method for determining a starter speed of a starter of a start-stop system.

FIG. 2 shows a schematic flow chart of an example method for determining a starter speed of a starter of a start-stop system.

FIG. 3 shows a schematic flow chart of an example method for determining a starter speed of a starter of a start-stop system.

FIG. 4 shows a schematic flow chart of an example method for setting a starting duration of a pinion-type starter of a start-stop system.

FIG. 5 shows a schematic diagram for representing the changes to a reference curve in the case of a starter that runs up rapidly and a starter that runs up slowly.

### DETAILED DESCRIPTION OF EXAMPLE EMBODIMENTS

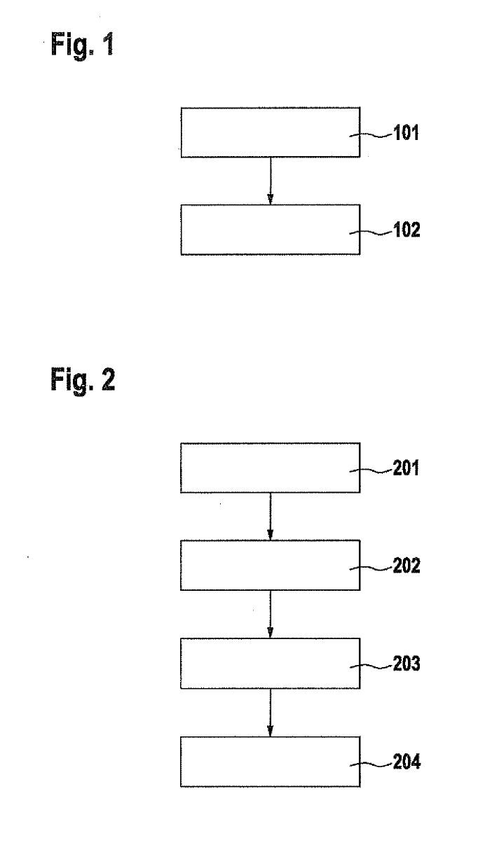

A schematic flow chart of a first exemplary embodiment of the method of the present invention for determining a starter speed of a starter of a start-stop system is shown in FIG. 1. The first exemplary embodiment according to FIG. 1 includes the method steps 101 and 102; in method step 101, at least one electrical variable of the starter being measured during a run-up of the starter. Examples of such an electrical variable to be measured include the amount of current taken up during the starter run-up or the power of the starter taken up during the run-up of the starter. In method step 102, the current starter speed is determined as a function of the at least one measured electrical variable.

FIG. 2 shows a schematic flow chart of a second exemplary embodiment of the method of the present invention for determining a starter speed of a starter of a start-stop system, the method including the method steps 201 to 204.

In method step 201, the starter current of the starter is measured during the run-up of the starter. In method step 202, an integration value is provided or calculated by integrating the measured starter current over the time of the starter run-up. Alternatively, or in addition, the measured starter current may also be corrected in a first step, using a specific offset, in order to provide, in a second step, the integration value by integrating the corrected starter current over the time of the starter run-up.

In method step 203, a specific reference speed and a specific reference integration value for a plurality of instants during the time of the starter run-up are looked up or ascertained in a look-up table (LUT). These instants of the time may also be referred to as points of reference.

In method step 204, the current starter speed is calculated as a function of the provided integration value, the provided reference speed and the provided reference integration value. In this context, the current starter speed is calculated, in particular, from a quotient of a product of the integration value and the reference speed, and the reference integration value.

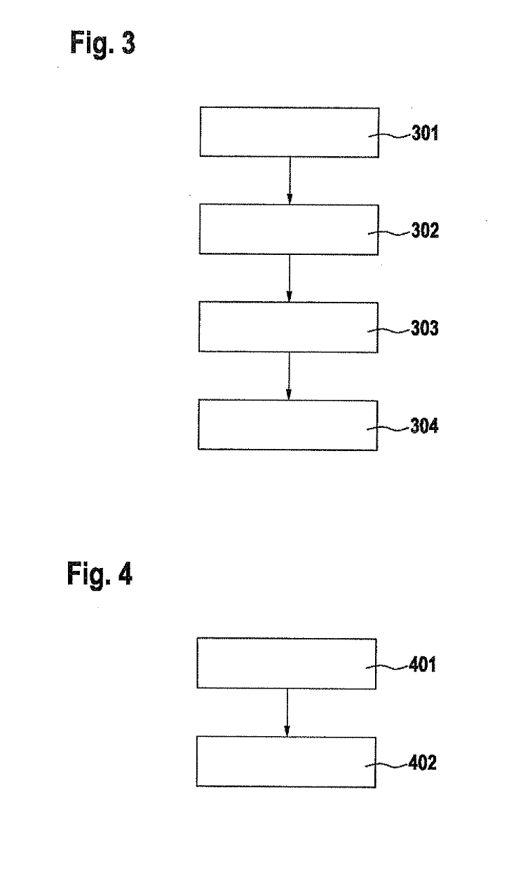

A schematic flow chart of a third exemplary embodiment of the method of the present invention for determining a starter speed of a starter of a start-stop system is shown in FIG. 3, the method including the method steps 301-304.

In method step 301, the starter current is measured during the run-up of the starter. In method step 302, the starter voltage dropping at the starter during the run-up of the starter is measured. In method step 303, the electric power taken up by the starter is calculated as a function of the measured starter current and the measured starter voltage. In method step 304, the current starter speed is calculated as a function of a reference speed, the calculated electrical energy, and a reference energy. In this context, the current starter speed is preferably calculated as a product of the reference speed and a square root of a quotient of the calculated electrical energy and the reference energy.

FIG. 4 shows a schematic flow chart of an exemplary embodiment of a method of the present invention for setting a starting duration of a pinion-type starter of a start-stop system, the method including the method steps 401 and 402.

In method step 401, the current starter speed of the pinion-type starter is determined, for example, as according to an exemplary embodiment of FIGS. 1-3. In method step 402, the starting duration of the pinion-type starter is set as a function of the determined, current starter speed in such a manner, that the starter speed becomes synchronous with the speed of an engine of the motor vehicle that is running down.

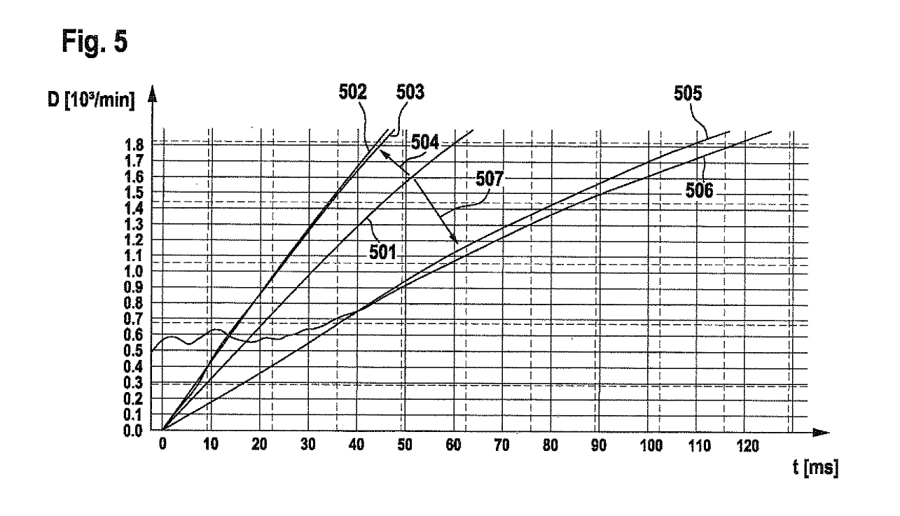

An example of the method of functioning of the present invention is represented in FIG. 5. In this context, FIG. 5 shows a schematic t-D graph for representing the changes to a reference curve 501 in the case of a starter that runs up rapidly and a starter that runs up slowly. In FIG. 5, t designates the time in ms, D designates the speed of the starter in 10³/min and 501 designates the reference curve stored in the look-up table. In addition, curves 502 and 503 show examples of a starter that runs up rapidly. Specifically, 502 is a measured curve, and 503 is the reference curve 501, which is bent according to the present invention and lies very close to curve 502 after application of the present invention. In this connection, arrow 504 illustrates the bending of reference curve 501 towards the D axis in the case of a starter that currently runs up rapidly. Furthermore, curves 505 and 506 show examples of a starter that runs up slowly. In an analogous manner, 506 is, herewith, a measured curve, and 505 is the reference curve 501, which is bent according to the present invention and lies very close to curve 505 after application of the present invention. In this context, arrow 507 illustrates the bending of reference curve 501 towards the t axis in the case of a starter that currently runs up slowly.

1-14. (canceled)

15. A method for determining a starter speed of a starter of a start-stop system, comprising:
measuring at least one electrical variable of the starter during a run-up of the starter; and
determining a current starter speed as a function of the at least one measured electrical variable.

16. The method as recited in claim 15, wherein to measure the at least one electrical variable, one of a starter current or a starter voltage is measured during the run-up of the starter.

17. The method as recited in claim 15, wherein the current starter speed is determined as a function of an integration value provided by integrating the at least one electrical variable, the at least one electrical variable including a measured starter current, over a time of the starter run-up.

18. The method as recited in claim 15, wherein the current starter speed is determined as a function of an integration value, wherein a measured starter current is corrected using an offset and the integration value is provided by integrating a corrected starter current.

19. The method as recited in claim 17, wherein the current starter speed is determined as a function of the provided integration value, a reference speed and a reference integration value.

20. The method as recited in claim 19, wherein the current starter speed is calculated from a quotient of a product of the integration value and the reference speed, and the reference integration value.

21. The method as recited in claim 19, wherein the reference speed and the reference integration value for a plurality of instants during the time of the starter run-up are stored in a look-up table.

22. The method as recited in claim 15, wherein to measure the at least one electrical variable, a starter current during the starter run-up and a starter voltage dropping at the starter during the starter run-up are measured, and the electrical energy taken up by the starter is calculated as a function of the measured starter current and the measured starter voltage.

23. The method as recited in claim 22, wherein to determine the current starter speed, the current starter speed is calculated as a function of a reference speed, the calculated electrical energy, and a reference energy.

24. The method as recited in claim 23, wherein the current starter speed is calculated as a product of the reference speed and a square root of a quotient of the calculated electrical energy and the reference energy.

25. The method as recited in claim 15, wherein the current starter speed is calculated based on the following formula:
$${n}_{act} ( {t}_{1} ) = \frac{{n}_{ref} ( {t}_{1} ) \cdot {I}_{int} ( {t}_{1} )}{{I}_{ref} ( {t}_{1} )} ,$$
where n_{act}(t₁) denotes a calculated speed at time t₁, n_{ref}(t₁) denotes a reference speed at time Iᵢₙₜ(t₁) denotes a current integral at time t₁ and I_{ref}(t₁) denotes a current integral from the reference measurement at time t₁.

26. The method as recited in claim 15, wherein the current starter speed is calculated based on the following formula:
$${n}_{act} ( {t}_{1} ) = {n}_{ref} ( t 1 ) \cdot \sqrt{\frac{E ( {t}_{1} )}{{E}_{ref} ( {t}_{1} )}} ,$$
where n_{act}(t₁) denotes the calculated speed at time t₁, n_{ref}(t₁) denotes a reference speed at time t₁, E(t₁) denotes a taken-up energy at time t₁, and E_{ref}(t₁) denotes a taken-up energy from the reference measurement at time t₁.

27. A method for setting a starting duration of a pinion-type starter, of a start-stop system, comprising:
measuring at least one electrical variable of the starter during a run-up of the starter; and
determining a current starter speed as a function of the at least one measured electrical variable; and
setting the starting duration of the starter as a function of the determined, current starter speed in such a manner that the starter speed becomes synchronous with a speed of a combustion engine that is running down.

28. A device for determining a starter speed of a starter of a start-stop system, comprising:
a measuring arrangement to measure at least one electrical variable of the starter during a run-up of the starter; and
a determining arrangement to determine a current starter speed as a function of the at least one measured electrical variable.

29. A start-stop system, comprising:
a starter; and
a device for determining a starter speed of the starter wherein the device includes a measuring arrangement to measure at least one electrical variable of the starter during a run-up of the starter, and a determining arrangement to determine a current starter speed as a function of the at least one measured electrical variable.
